(19) United States
(12) Patent Application Publication
(10) Pub. No.: US 2025/0261029 A1
(43) Pub. Date: Aug. 14, 2025

(54) Intelligent Geo-Fencing Based Load Balancing

(71) Applicant: Bank of America Corporation, Charlotte, NC (US)

(72) Inventors: Tushar Jain, West Hills, CA (US); Kalyan Pallapolu, Charlotte, NC (US); Stephen T. Shannon, Charlotte, NC (US); Elvin Crabbe, Waxhaw, NC (US)

(21) Appl. No.: 18/437,378

(22) Filed: Feb. 9, 2024

(51) Int. Cl. H04W 28/02; H04W 4/021

(52) U.S. Cl. CPC H04W 28/0226; H04W 4/021

(57) ABSTRACT

Arrangements for geo-fencing based load balancing are provided. A computing platform may identify a current load for a plurality of entity locations based on geo-location data determined from a user computing device, associate provided data, and/or image data. A load for each location may be compared to a location-specific threshold to determine a flag for each location identifying whether each location is over threshold or under threshold. A request for service may be received from a user at a first entity location. The flag for the first entity location may be identified and, if the flag is under threshold, the user request may be processed at the first entity location. If the flag is over threshold, a second entity location that is under may be identified. The computing platform may initiate a communication session between devices at the first location and the second location to enable processing of the request.

### BACKGROUND

Aspects of the disclosure relate to electrical computers, systems, and devices for geo-fencing based load balancing.

Large enterprise organizations often operate multiple entity locations that are distributed in various geographical areas. However, users with particular needs might not be able to receive service at a desired location because of a high volume of customers, lack of associates of the enterprise organization with the necessary skills sets, and the like. Accordingly, it would be advantageous to leverage geo-fencing technology to understand and predict user volumes and leverage video communications to enable cross-location communication.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure provide effective, efficient, scalable, and convenient technical solutions that address and overcome the technical issues associated with load balancing between various geographic locations.

In some examples, a computing platform may identify a current load for a plurality of enterprise organization locations. In some examples, the current load may be determined in real-time or near real-time and may be based on one or more of geo-location data determined from a user computing device, associate provided data, and/or image data analyzed using facial recognition techniques. In some arrangements, a determined load for each entity location may be compared to a location-specific threshold to determine a flag for each location identifying whether each entity location is currently over threshold (e.g., does not have sufficient resources to handle the determined load) or under threshold (has sufficient resources to handle the current load and, therefore, may be able to assist other locations that are over threshold).

In some examples, a request for service may be received from a user at a first entity location. The computing platform may evaluate the flag associated with the first entity location. If the flag is under threshold, the user request may be processed at the first entity location. If the flag is over threshold, a central assignment system of the computing platform may identify a second entity location that is under threshold and has associates with particular skills or abilities to address the request. The computing platform may initiate a communication session between a computing device at the first entity location and a computing device at the second entity location to enable the associate at the second entity location to process the request of the user at the first entity location. The request may then be processed and the communication session terminated.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A-1B depict an illustrative computing environment for geo-fencing based load balancing in accordance with one or more aspects described herein;

FIGS. 2A-2F depict an illustrative event sequence for geo-fencing based load balancing in accordance with one or more aspects described herein;

FIG. 3 depicts an illustrative method for geo-fencing based load balancing in accordance with one or more aspects described herein; and

FIG. 4 illustrates one example environment in which various aspects of the disclosure may be implemented in accordance with one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As discussed herein, enterprise organizations often have a plurality of locations distributed throughout various geographic areas. However, it can be difficult to manage customer expectations because understanding a current number of customers, predicted number of customers, as well as needs of each customer, can be difficult.

Accordingly, aspects described herein leverage geo-fencing to understand and predict current workload or load at each location. For instance, customers of the enterprise organization may use a mobile application downloaded to the user's device to execute events with the enterprise organization. In some examples, based on permissions provided by the user, the mobile application may provide current geo-location coordinates (e.g., based on global positioning system (GPS) data from the user device) to compare to geo-location coordinates of an entity location, of a geo-fenced perimeter around the entity location, and the like. Accordingly, detection of a user device within the geo-fenced area or at the entity location may provide an indication of a number of customers at the entity location or predicted to arrive at the entity location.

In another example, current needs may be based on users who physically arrive at the location and are met by an associate of the enterprise organization who indicates the user is present and, thus, better identifies a current number of customers at the entity location. In still another example, image data captured or users entering or leaving the entity location may be used to understand and predict current number of users or needs.

The identified load (e.g., number of customers) may be compared to a location-specific threshold to determine whether a particular location is at or over capacity. If so, the location may be flagged as over capacity. If not, the location may be flagged as under capacity. A central assignment system may then identify needs of over capacity locations and automatically initiate electronic communication sessions with entity locations that are under capacity to serve the needs of users.

These and various other arrangements will be discussed more fully below.

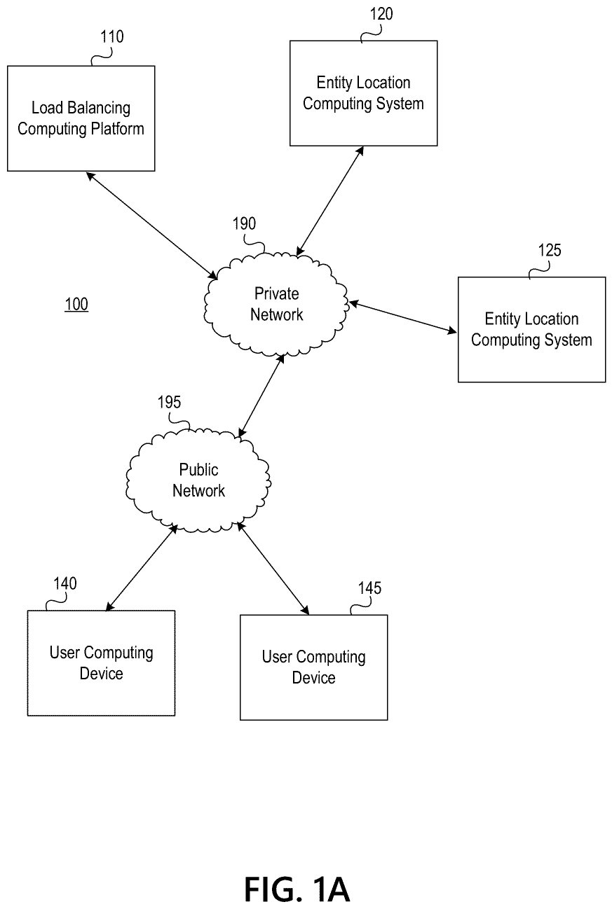

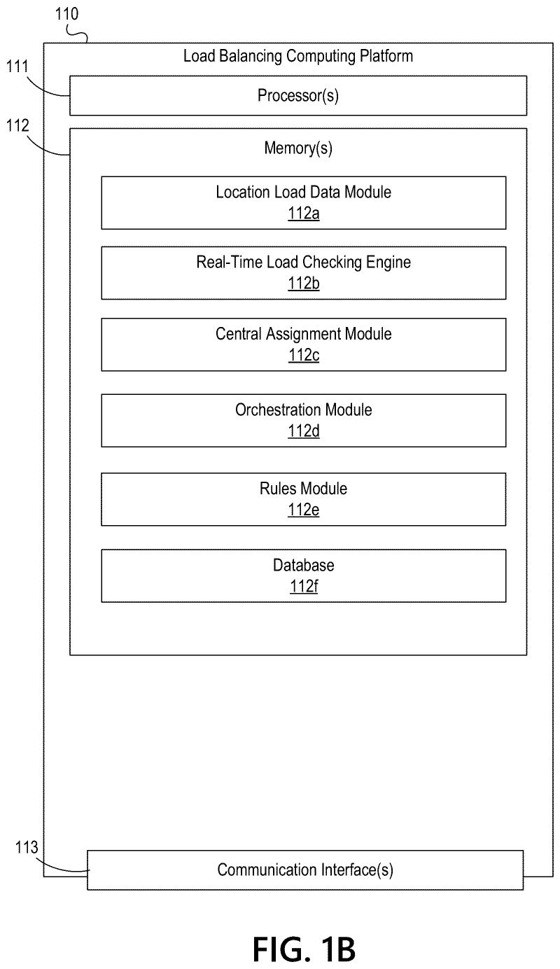

FIGS. 1A-1B depict an illustrative computing environment for implementing intelligent geo-fencing based load balancing in accordance with one or more aspects described herein. Referring to FIG. 1A, computing environment 100 may include one or more computing devices and/or other computing systems. For example, computing environment 100 may include load balancing computing platform 110, entity location computing system 120, entity location computing system 125, user computing device 140 and user computing device 145. Although two entity location computing systems 120, 125 and two user computing devices 140, 145 are shown, any number of systems or devices may be used without departing from the invention.

Load balancing computing platform 110 may be or include one or more computing devices (e.g., servers, server blades, or the like) and/or one or more computing components (e.g., memory, processor, and the like) and may be configured to dynamically, and in real-time, assess current loads of an entity location and balance loads between entity locations. For instance, load balancing computing platform 110 may identify a current load at a plurality of entity locations. In some examples, the load may include a current number of users or customers at a respective entity location. In some arrangements, the load may be based on geo-location data of user mobile devices (e.g., GPS coordinates matching geo-location coordinates of an entity location or being within a geo-fenced perimeter of the entity location), a physical presence of a user as reported by an associate of the enterprise organization, and/or image data captured of users entering and existing a respective entity location. A current load may be compared to a load threshold that is specific to each entity location (e.g., based on size, number of associates, and/or other facilities and capabilities). If the current load is at or above the threshold, the entity location may be flagged as over threshold or over capacity. If the current load does not exceed the threshold, the entity location may be flagged as under capacity.

Load balancing computing platform 110 may receive load and flag data and may analyze over threshold entity locations to identify particular needs (e.g., particular skills, language capabilities, and the like) and may identify one or more under threshold locations with capacity and particular skills to receive some of the overcapacity load. Load balancing computing platform 110 may the initiate one or more electronic communication sessions (e.g., video communications, telephone communications, or the like) between computing devices at the over threshold location and the under threshold location identified to assist.

Entity location computing system 120 and/or entity location computing system 125 may be or include one or more computing devices (e.g., servers, server blades, or the like) and/or one or more computing components (e.g., memory, processor, and the like) and may be configured to host or execute one or more enterprise organization applications or systems. For instance, entity location computing system 120 and/or entity location computing system 125 may host or execute internal or customer-facing applications, may enable communications between entity locations and users, and the like. In some examples, entity location computing system 120 and/or entity location computing system 125 may be or include one or more self-service kiosks, such as an automated teller machine (ATM), automated teller assistant (ATA), or the like. The self-service kiosks may, in some examples, include video communication capability.

User computing device 140 and/or user computing device 145 may be or include a computing device such as a desktop computer, laptop computer, tablet, smartphone, wearable device, and the like, that is associated with a user (e.g., a customer) of the enterprise organization. User computing device 140 and/or user computing device 145 may execute a mobile application associated with the enterprise organization, may include global positioning system (GPS) capabilities to communication location data to load balancing computing platform 110, may receive user input, display one or more user interfaces, and the like.

As mentioned above, computing environment 100 also may include one or more networks, which may interconnect one or more of load balancing computing platform 110, entity location computing system 120, entity location computing system 125, user computing device 140 and/or user computing device 145. For example, computing environment 100 may include private network 190 and public network 195. Private network 190 and/or public network 195 may include one or more sub-networks (e.g., Local Area Networks (LANs), Wide Area Networks (WANs), or the like). Private network 190 may be associated with a particular organization (e.g., a corporation, financial institution, educational institution, governmental institution, or the like) and may interconnect one or more computing devices associated with the organization. For example, load balancing computing platform 110, entity location computing system 120, and/or entity location computing system 125, may be associated with an enterprise organization (e.g., a financial institution), and private network 190 may be associated with and/or operated by the organization, and may include one or more networks (e.g., LANs, WANs, virtual private networks (VPNs), or the like) that interconnect load balancing computing platform 110, entity location computing system 120, and/or entity location computing system 125, and one or more other computing devices and/or computer systems that are used by, operated by, and/or otherwise associated with the organization. Public network 195 may connect private network 190 and/or one or more computing devices connected thereto (e.g., load balancing computing platform 110, entity location computing system 120, and/or entity location computing system 125) with one or more networks and/or computing devices that are not associated with the organization. For example, user computing device 140 and/or user computing device 145, might not be associated with an organization that operates private network 190 (e.g., because user computing device 140 and/or user computing device 145 may be owned, operated, and/or serviced by one or more entities different from the organization that operates private network 190, one or more customers of the organization, one or more employees of the organization, public or government entities, and/or vendors of the organization, rather than being owned and/or operated by the organization itself), and public network 195 may include one or more networks (e.g., the internet) that connect user computing device 140 and/or user computing device 145 to private network 190 and/or one or more computing devices connected thereto (e.g., load balancing computing platform 110, entity location computing system 120, and/or entity location computing system 125).

Referring to FIG. 1B, load balancing computing platform 110 may include one or more processors 111, memory 112, and communication interface 113. A data bus may interconnect processor(s) 111, memory 112, and communication interface 113. Communication interface 113 may be a network interface configured to support communication between load balancing computing platform 110 and one or more networks (e.g., network 190, network 195, or the like). Memory 112 may include one or more program modules having instructions that when executed by processor(s) 111 cause load balancing computing platform 110 to perform one or more functions described herein and/or one or more databases that may store and/or otherwise maintain information which may be used by such program modules and/or processor(s) 111. In some instances, the one or more program modules and/or databases may be stored by and/or maintained in different memory units of load balancing computing platform 110 and/or by different computing devices that may form and/or otherwise make up load balancing computing platform 110.

For example, memory 112 may have, store and/or include location load data module 112a. Location load data module 112a may store instructions and/or data that may cause or enable the load balancing computing platform 110 to determine a current load (e.g., current number of users or customers at an entity location at a current time or within a predetermined time of the current time) at one or more entity locations. For instance, each entity location may be associated with an enterprise organization having an application, such as a mobile application, that may execute on one or more user devices of one or more users or customers, such as user computing device 140, user computing device 145, or the like. Load balancing computing platform 110 may receive (e.g., with permission of the user) geo-location data of the user computing devices 140, 145 to determine a current location of each user computing device 140, 145. In some examples, load balancing computing platform may compare the geo-location data (e.g., longitude and latitude coordinates captured from a global positioning system executing in each user computing device) to geo-location data of one or more entity locations to determine whether a match exists. If a match exists, the user associated with a respective computing device may be associated with that entity location.

If a match does not exist, load balancing computing platform 110 may determine whether the geo-location data of the user computing device is within a geo-fenced area (e.g., a predetermined distance of) an entity location. If the geo-location data of the user computing device is within the geo-fenced area, the user may be counted as being associated with the entity location (e.g., the user is at or approaching the entity location).

Additionally or alternatively, load data may be received from one or more associates working within the one or more entity locations. For instance, as users enter or are serviced within the entity location, an associate or other employee of the enterprise organization may input the presence of the user into an associate computing device which may transmit the presence of that user to the load balancing computing platform 110 to be counted as associated with that entity location at that time.

In still other examples, image data of users entering and exiting an entity location may be captured and analyzed (e.g., using facial recognition techniques) to identify a user and count the user as associated with the entity location. For instance, holistic and/or feature-based models may be used to identify a user as the user enters or exits the entity location and the user may be added to a count for the location (e.g., if the user is entering) or may be subtracted from the count (e.g., if the user is exiting).

The load data may be computed on a continuous basis, as users are detected, on a predetermined schedule (e.g., every minute, every five minutes, or the like) to provide real-time or near real-time load data for each entity location. Further, in some examples, the location load data module 112a may determine the load by not only identifying users or customers within or approaching the location but also by identifying a number of associates or workers at that location on that particular day, time, or the like. Accordingly, the load may be determined as a total number of people within or approaching the location minus an identified number of employees or associates at that location for that day or time.

Load balancing computing platform 110 may further have, store and/or include real-time load checking engine 112b. Real-time load checking engine 112b may store instructions and/or data that may cause or enable the load balancing computing platform 110 to evaluate a current load or workload at each entity location as compared to a threshold for the location. For instance, each entity location may have a particular threshold that is determined for that location. The threshold may represent a point at which service may be delayed to customers due to insufficient staffing of associates at the location. In some examples, the threshold may be dynamically determined each day or at one or more points throughout the day based on staffing changes (e.g., associates on vacation, associates out sick, associated coming in late or leaving early, or the like). Accordingly, in some examples, the threshold might not only be specific to the entity location but also specific to that particular day, day of week, time of day, or the like.

The real-time load checking engine 112b may compare the load data (e.g., as determined by the location load data module 112a) for the location to the threshold for that location (and, in some examples, for that particular day, time, or the like). If the load is greater than or equal to the threshold, the location may be flagged as red or over threshold. If the load is less than the threshold, the location may be flagged as green or under threshold. The flag identified for each location may be stored by the load balancing computing platform 110 (e.g., in database 112f).

Load balancing computing platform 110 may further have, store and/or include central assignment module 112c. Central assignment module 112c may store instructions and/or data that may cause or enable the load balancing computing platform 110 to identify entity locations flagged as red or over threshold, and identify, based on users present within the entity location (e.g., based on user profile data retrieved from a user's mobile application, from associate data, from a user profile retrieved based on image identification, or the like) one or more particular skills to accommodate users within the entity location flagged as red or over threshold. Central assignment module 112c may then identify other entity locations flagged as green or under threshold that have the one or more particular skills to accommodate the users at the first location flagged as red or over threshold. Central assignment module 112c may then send the identified second location and/or one or more particular associates at the second location having the one or more particular skills to the orchestration module 112d.

Orchestration module 112d may store instructions and/or data that may cause or enable the load balancing computing platform 110 to generate an instruction or command to reserve the associate at the second location with the particular skills. The command or instruction may be transmitted to the second location and executed to reserve the associate. Further, orchestration module 112d may generate a command or instruction causing a computing device at the first entity location (e.g., entity location computing system 120) to initiate a communication session with a computing device at the second entity location (e.g., entity location computing system 125) to enable the user at the first entity location to receive the desired service. In some examples, the communication session may be a video communication session between the user, physically located at the first entity location, and the associate, physically located at the second entity location.

Load balancing computing platform 110 may further have, store and/or include rules module 112e. Rules module 112e may store instructions and/or data that may cause or enable the load balancing computing platform 110 to store rules associated with functions, skills, parameters, and the like, of each entity location. For instance, rules module 112e may store information related to associate vacation, associates logged in or physically present at the entity location on that day, skills of each associate at each location (e.g., particular types of products or services that a user is authorized to provide service for or in which the associate is an expert, or the like), language skills of each associate at each entity location (e.g., primary and secondary languages spoken by each associate to accommodate speakers of various languages, or the like), official holidays of each entity location, technical facilities of each location (e.g., availability of video conferences, use of meta, or the like), and the like. The rules for each entity location may be stored by rules module 112e and accessed by central assignment module 112c to identify secondary locations and particular associates to provide service to users at the first entity location.

Load balancing computing platform 110 may further have, store and/or include database 112f. Database 112f may store data related to current load data, flags identified for each entity location, and/or other data that enables performance of aspects described herein by the load balancing computing platform 110

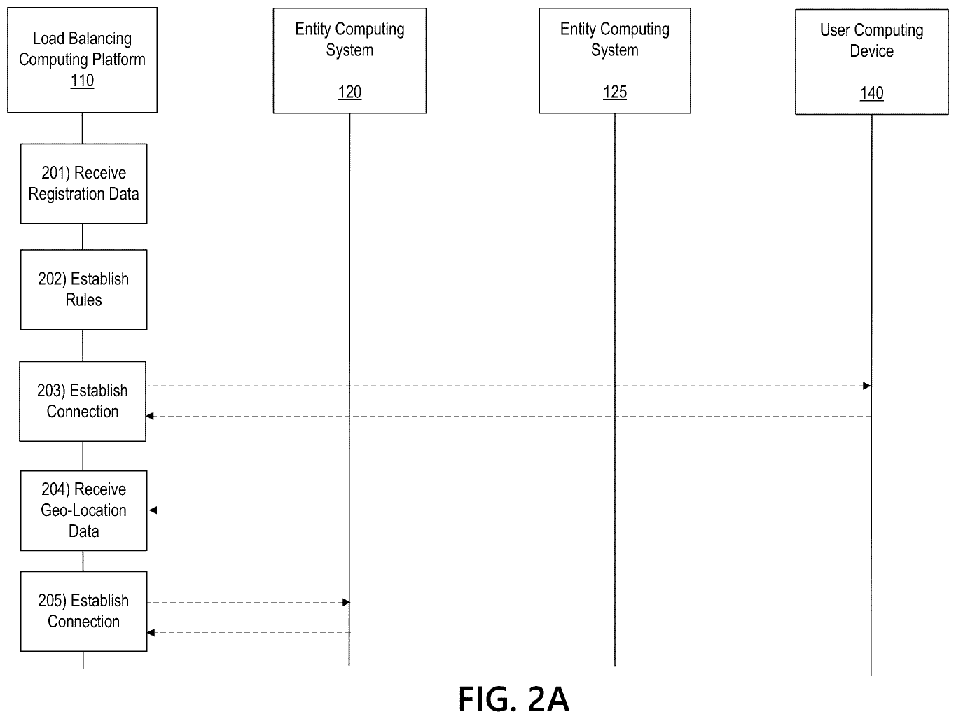

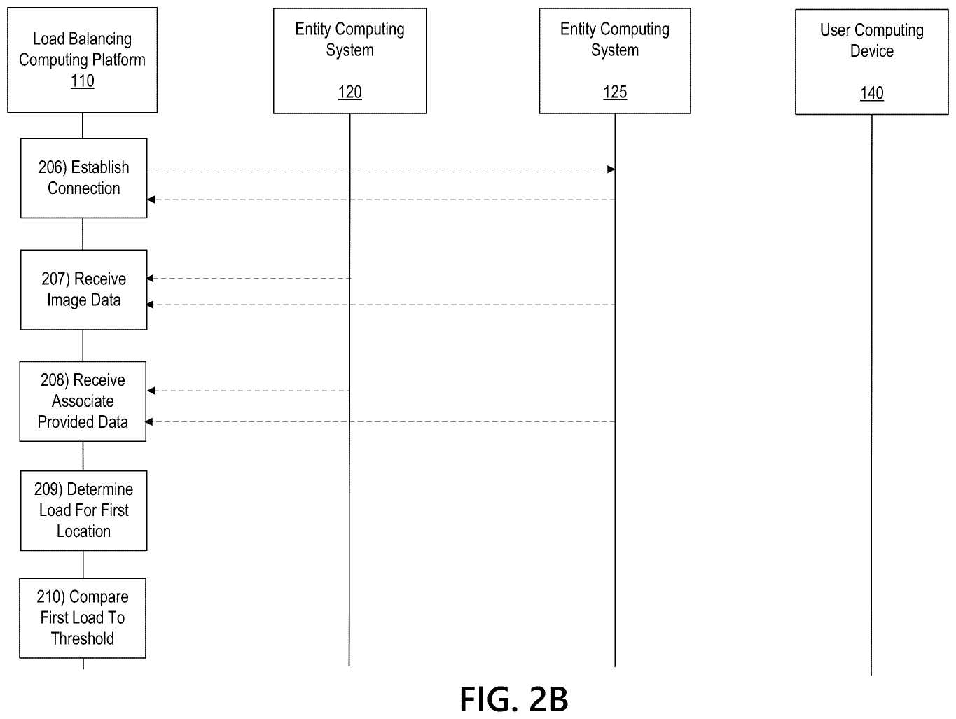

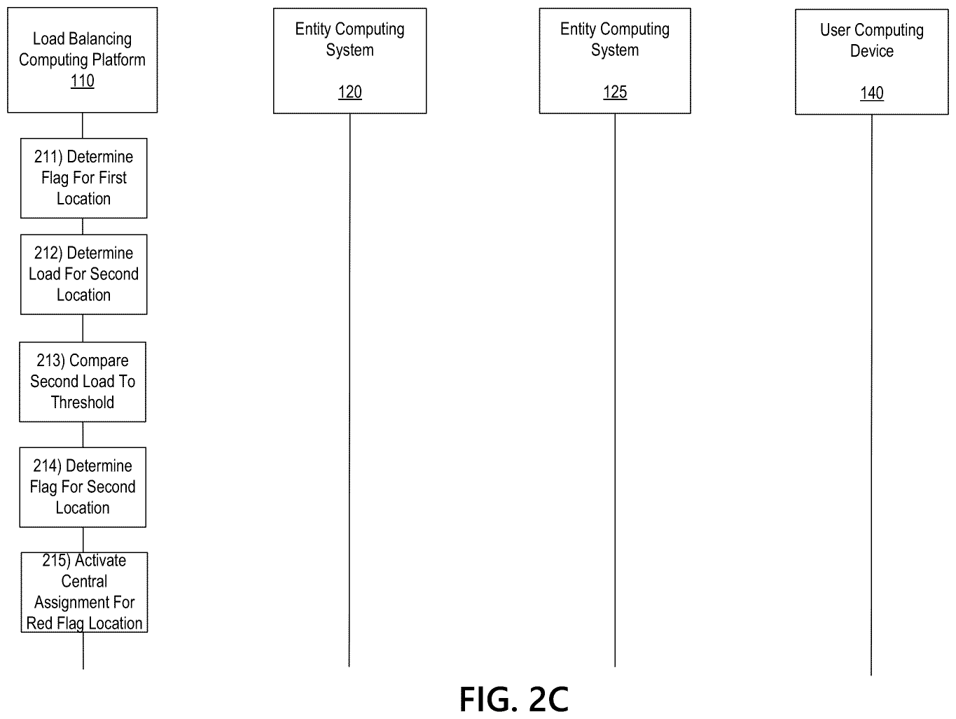

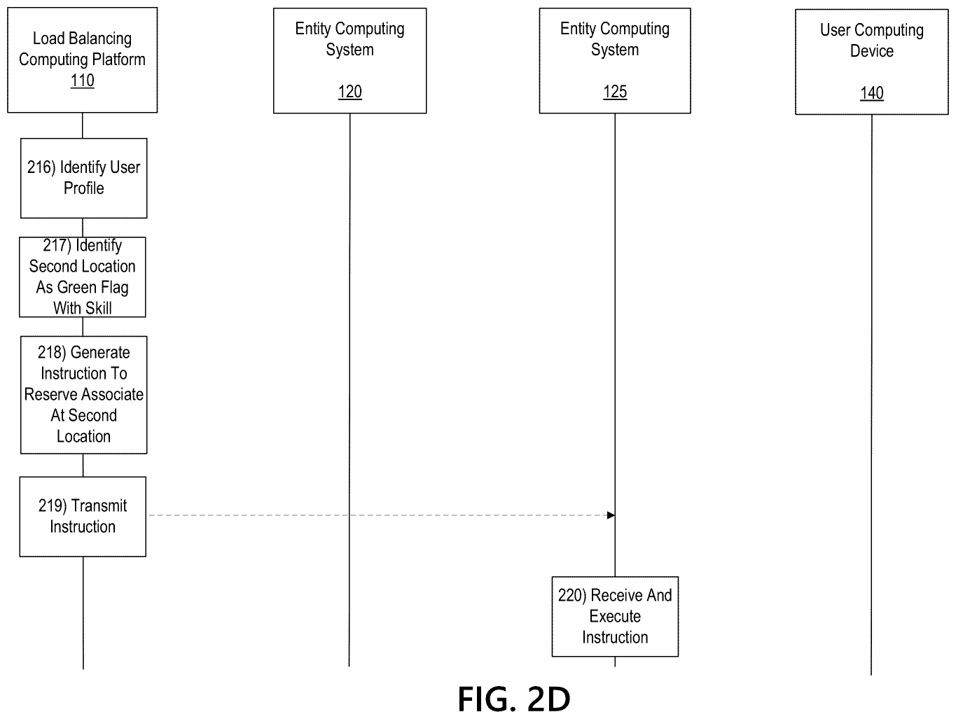

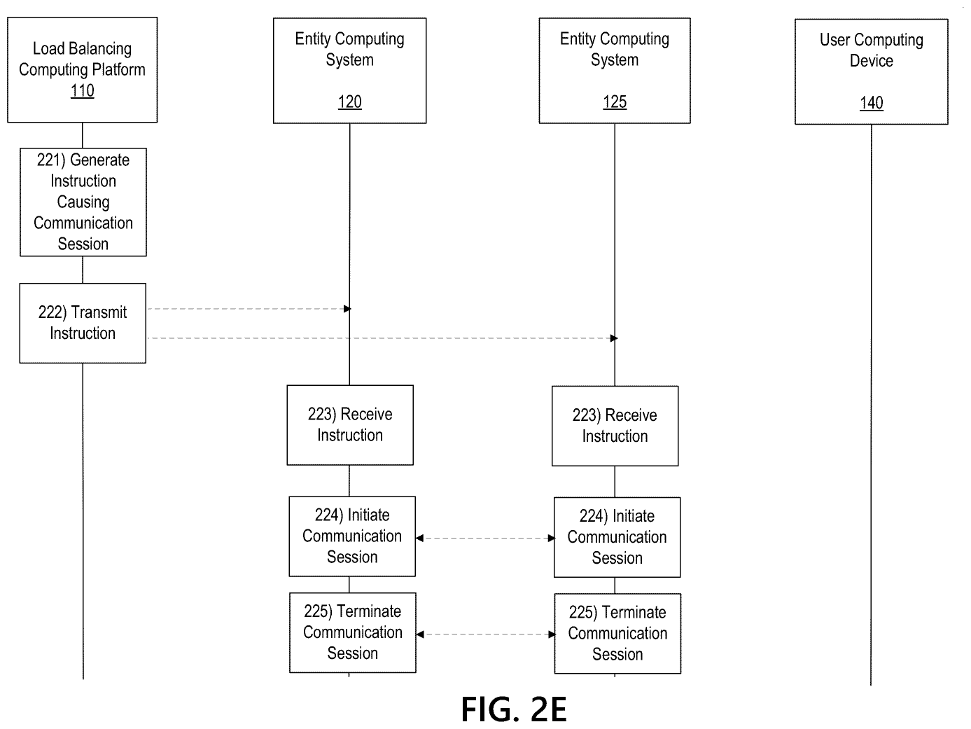

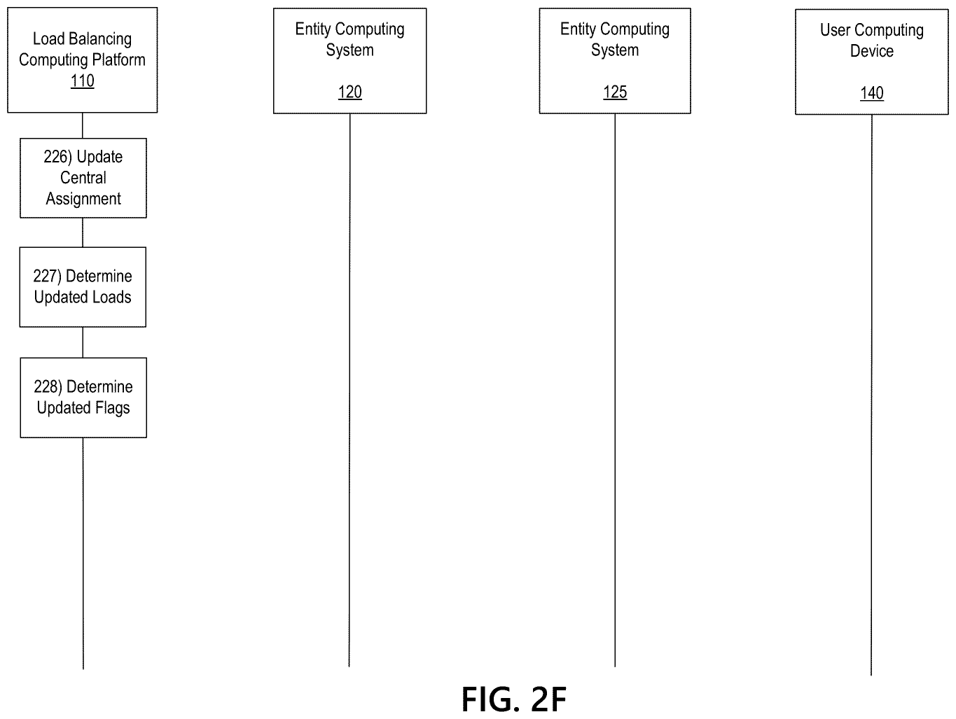

FIGS. 2A-2F depict one example illustrative event sequence for providing geo-location based load balancing in accordance with one or more aspects described herein. The events shown in the illustrative event sequence are merely one example sequence and additional events may be added, or events may be omitted, without departing from the invention. Further, one or more processes discussed with respect to FIGS. 2A-2F may be performed in real-time or near real-time.

With reference to FIG. 2A, at step 201, load balancing computing platform 110 may receive registration data. For instance, load balancing computing platform 110 may receive requests to register with the load balancing computing platform 110 from a plurality of users or customers of the enterprise organization. In some examples, the registration data may include user permissions (e.g., access to GPS data from user devices, access to the mobile application, or the like), user preferences (e.g., language preferences, particular products or services of interest to the user, or the like), user device identifying data, user identifying data, and the like. The registration data may be stored in a user profile associated with each user.

At step 202, load balancing computing platform 110 may identify rules for one or more entity locations of the enterprise organization and may store the rules. For instance, data related to number of associates at each location, geo-location coordinates of each location, geo-fence data for each location, skills for associates at each location, and the like, may be identified and used to determine rules for each location. In some examples, rules may be static such that they do not change from day to day. Alternatively, rules for any particular day, time of day, or the like, may be dynamically determined based on real-time or current associate login or attendance data, or the like. The rules may identify associates having particular skills at various entity locations, as well as availability of those associates.

At step 203, load balancing computing platform 110 may establish a connection with user computing device 140. For instance, load balancing computing platform 110 may establish a first wireless connection with user computing device 140. Upon establishing the first wireless connection, a communication session may be initiated between load balancing computing platform 110 and user computing device 140. Although a connection to one user computing device 140 is shown and described, connections to additional user computing devices may be established in parallel without departing from the invention.

At step 204, load balancing computing platform 110 may receive geo-location data from the user computing device 140. For instance, geo-location data including coordinates captured via a GPS system of the user computing device 140 may be received by the load balancing computing platform 110 during the communication session initiated upon establishing the first wireless connection.

At step 205, load balancing computing platform 110 may establish a connection with entity location computing system 120, which may be a computing device or system at a first entity location of the enterprise organization. For instance, load balancing computing platform 110 may establish a second wireless connection with entity location computing system 120. Upon establishing the second wireless connection, a communication session may be initiated between load balancing computing platform 110 and entity location computing system 120.

With reference to FIG. 2B, at step 206, load balancing computing platform 110 may establish a connection with entity location computing system 125, which may be a computing device or system at a second entity location of the enterprise organization. For instance, load balancing computing platform 110 may establish a third wireless connection with entity location computing system 125. Upon establishing the third wireless connection, a communication session may be initiated between load balancing computing platform 110 and entity location computing system 125.

At step 207, image data from the first entity location and second entity location may be received by the load balancing computing platform 110. For instance, entity location computing system 120 may capture image data from the first entity location and entity location computing system 125 may capture image data from the second entity location. The computing systems 120, 125 may then transmit the image data to the load balancing computing platform 110 for image analysis and load determination.

At step 208, load balancing computing platform 110 may receive associate provided data. For instance, associates at first entity location may input data related to a physical presence of one or more users or customers that may then be transmitted to the load balancing computing platform via entity location computing system 120. Similarly, associates at second entity location may input data related to a physical presence of one or more users or customers that may then be transmitted to the load balancing computing platform via entity location computing system 125.

At step 209, load or work load for the first entity location may be determined. For instance, geo-location data of one or more users may be compared to geo-location data of the first entity location and geo-fence data for the first entity location to identify users within the geo-fenced area (e.g., approaching or at the first entity location) or at the first entity location (e.g., geo-location data matches). In addition, image data from the first entity location received via entity location computing system 120 may be analyzed using facial recognition techniques to identify users entering or exiting the first entity location. Further, associate provided data related to customers or users physically present at the first entity location may be identified. A number of users identified via geo-location data, image data and associate provided data may be summed. In some examples, a number of associates for the first entity location may be identified and subtracted from the sum determined (e.g., if image data may capture associates as well as customers). Accordingly, a load for the first entity location may be determined.

At step 210, the load for the first entity location may be compared to a threshold for the first entity location. For instance, a threshold unique to the first entity location and, in some examples, dynamically determined based on associate login or attendance data, day of week, or the like, may be identified or retrieved. The load for the first entity location may be compared to the threshold.

With reference to FIG. 2C, based on the comparing, a flag for the first entity location may be determined at step 211. If the load meets or exceeds the threshold, the first entity location may be flagged as red or over threshold. If the load is below the threshold, the first entity location may be flagged as green or under threshold. The identified flag for the first entity location may be stored (e.g., in database 112f).

At step 212, load or work load for the second entity location may be determined. For instance, geo-location data of one or more users may be compared to geo-location data of the second entity location and geo-fence data for the second entity location to identify users within the geo-fenced area (e.g., approaching or at the second entity location) or at the second entity location (e.g., geo-location data matches). In addition, image data from the second entity location received via entity location computing system 125 may be analyzed using facial recognition techniques to identify users entering or exiting the second entity location. Further, associate provided data related to customers or users physically present at the second entity location may be identified. A number of users identified via geo-location data, image data and associate provided data may be summed. In some examples, a number of associates for the second entity location may be identified and subtracted from the sum determined (e.g., to account for image data that may capture associates as well as customers). Accordingly, a load for the second entity location may be determined.

At step 213, the load for the second entity location may be compared to a threshold for the second entity location. For instance, a threshold unique to the second entity location and, in some examples, dynamically determined based on associate login or attendance data, day of week, or the like, may be identified or retrieved. The load for the second entity location may be compared to the threshold.

Based on the comparing, a flag for the second entity location may be determined at step 214. If the load meets or exceeds the threshold, the second entity location may be flagged as red or over threshold. If the load is below the threshold, the second entity location may be flagged as green or under threshold. The identified flag for the second entity location may be stored (e.g., in database 112f).

At step 215, load balancing computing platform 110 may activate central assignment for locations flagged as red or over threshold. For instance, as an example, if the first entity location is flagged as red or over threshold, central assignment may be activated based on the red flag to identify other entity locations and/or associates at those locations to accommodate users at the first entity location.

For instance, with reference to FIG. 2D, at step 216, load balancing computing platform 110 may identify and/or retrieve a user profile for one or more users at the first entity location that may need assistance. For instance, a last user to enter the first entity location (e.g., based on geo-location data, image data, associate data, or the like) may be identified (e.g., from a mobile application executing on the user computing device 140, from analyzed image data, from associate identifying data, or the like) and a user profile may be retrieved. The user profile may identify language preferences, products or services of interest for the user, or the like. Accordingly, based on the user profile data, or other data associated with the user, particular skills or abilities of an associate to service the user may be identified.

At step 217, load balancing computing platform 110 may identify a second entity location having a green or under threshold flag and having the particular skills or abilities identified for the user. For instance, central assignment module 112c may identify the second entity location as green or under threshold and may identify that an associate at the second entity location has the skills or abilities to service the user physically located at the first entity location.

At step 218, load balancing computing platform 110 may generate an instruction or command to reserve the associate at the second entity location having the particular skills or abilities identified. For instance, load balancing computing platform 110 (e.g., via orchestration module 112d) may generate a command or instruction to reserve one or more particular associates to provide remote service to the user located at the first entity location.

At step 219, load balancing computing platform 110 may transmit or send the command or instruction to entity location computing system 125 at the second entity location. At step 220, entity location computing system 125 may receive and execute the instruction or command to reservice the identified associate.

With reference to FIG. 2E, at step 221, load balancing computing platform 110 may generate an instruction or command to initiate a communication session between computing devices at the first entity location and the second entity location, in order to enable the associate at the second entity location to provide remote service to the user at the first entity location. For instance, orchestration module 112d of load balancing computing platform 110 may generate one or more commands or instructions causing initiation of a video or other communication session between entity location computing system 120 at the first entity location and entity location computing system 125 at the second entity location.

At step 222, load balancing computing platform 110 may transmit or send the generated instructions or commands to entity location computing system 120 and entity location computing system 125. In some examples, transmitting or sending the instructions or commands may cause the entity location computing system 120 and entity location computing system 125 to execute the commands and initiate a communication session, such as a video communication session.

At step 223, entity location computing system 120 and entity location computing system 125 may receive the commands or instructions and may execute the commands or instructions.

Accordingly, at step 224, entity location computing system 120 located at the first entity location, and entity location computing system 125 located at the second entity location may initiate a communication session. For instance, in some examples, a video-based communication session may be initiated between entity location computing system 120 and entity location computing system 125 to enable the user, located at the first entity location, to communicate with the associate, located at the second entity location, to receive desired service.

At step 225, at the conclusion of the session (e.g., when the associate has completed the desired service for the first user), entity location computing system 120 and/or entity location computing system 125 may terminate the communication session initiated at step 224 based on the commands from the load balancing computing platform 110.

With reference to FIG. 2F, at step 226, load balancing computing platform 110 may update the central assignment module 112c to reflect completion of the communication session. For instance, central assignment module 112c may be updated to reflect availability of associates at the second entity location based on termination of the communication session between the entity location computing system 120 and the entity location computing system 125.

Accordingly, in order to maintain real-time or near real-time data, the process may continue to evaluate current loads and assign updated flags as needed. Accordingly, at step 227, updated load data may be received from the first entity location and the second entity location (e.g., updated geo-location data, updated image data, updated associate provided data) may be received and may indicate current data (e.g., real-time or near real-time data). A current load at the first entity location and the second entity location may then be determined or identified based on the updated data.

At step 228, based on the updated loads, an updated flag of red (e.g., over threshold) or green (e.g., under threshold) may be assigned to the first entity location and the second entity location based on comparing the updated loads to thresholds specific to each entity location. Based on the updated flags, the process may continue to provide remote service to users at various locations through communication sessions between devices at different locations.

Although two entity location computing system 120, 125 are shown and described, additional entity location computing systems at additional entity locations may be evaluated (e.g., load data may be received and analyzed, flags assigned, and the like) without departing from the invention.

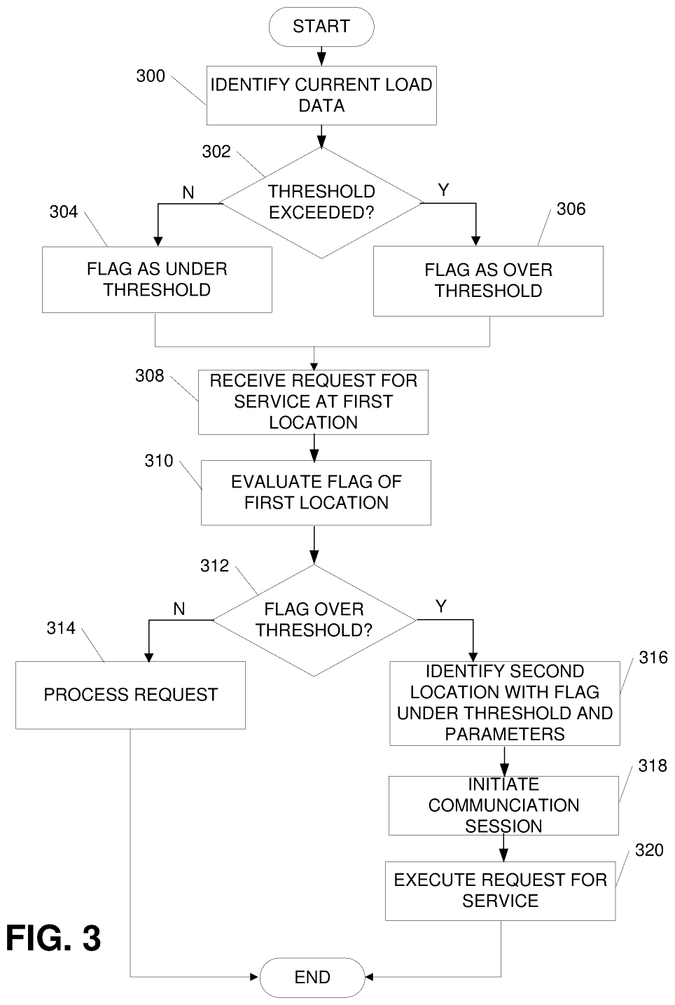

FIG. 3 is a flow chart illustrating one example method of intelligent geo-fencing based load balancing in accordance with one or more aspects described herein. The processes illustrated in FIG. 3 are merely some example processes and functions. The steps shown may be performed in the order shown, in a different order, more steps may be added, or one or more steps may be omitted, without departing from the invention. In some examples, one or more steps may be performed simultaneously with other steps shown and described. One of more steps shown in FIG. 3 may be performed in real-time or near real-time.

At step 300, a computing platform, such as load balancing computing platform 110, may identify current load data for a plurality of entity locations. The load data may be based on users physically present at a respective entity location or predicted to be physically present based on geo-location data of a user. For instance, load data for each entity location may be determined based on geo-location data of a user computing device (e.g., a device executing an application associated with the enterprise organization) matching or being within a predetermined radius of a geo-location of an entity location. In some examples, the predetermined radius may include a geo-fence. Further, the load may be determined based on associate provided data including identification of users within an entity location. Additionally or alternatively, the load may be based on image data captured of one or more users entering or exiting an entity location. The image data may be analyzed using facial recognition techniques to identify customer users vs. employees within the entity location.

At step 302, the load data for each entity location may be compared to a location-specific threshold for the respective location. In some examples, a load checking engine may be used to evaluate the load as compared to the threshold and the load may be evaluated in real-time or near real-time. If the load data for a location exceeds the location-specific threshold, the location may be flagged as over threshold at step 306. If the load data does not exceed the threshold, the location may be flagged as under threshold at step 304.

At step 308, a request for service may be received from a user at a first entity location. In some examples, the request for service may include one or more parameters (e.g., type of service, specific needs, language preferences, and the like). Additionally or alternatively, one or more parameters may be extracted from a user profile associated with the user requesting service (e.g., language preferences, types of accounts, or the like). For instance, a user profile associated with a user may be retrieved based on facial recognition analysis of image data, data from the mobile application executing on the user device, data provided by an associate, or the like. In some examples, user profile data may include data from previous interactions between the user and associates of the enterprise organization such that various preferences or services may be stored based on the previous interactions and used to predict skills or other parameters for the request.

At step 310, the computing platform may evaluate a current flag associated with the first entity location. At step 312, a determination may be made as to whether the current flag of the first entity location is over threshold or under threshold. If the current flag of the first entity location is under threshold, the request for service may be processed by an associate at the first entity location at step 314. If the current flag for the first location is over threshold, at step 316, the computing platform may identify a second entity location that is current flagged as under threshold and meets the parameters of the service request.

At step 318, the computing platform may initiate an electronic communication session between computing devices at the first entity location and the second entity location. For instance, an instruction, generated by the computing platform, may cause a secure communication session to be initiated between a computing device at the first entity location and a computing device at the second entity location. In some examples, the communication session may be a video communication session.

At step 318, the request for service may be executed by an associate located at the second entity location for the user at the first entity location via computing devices at the respective entity locations and the communication session initiated between the devices. In some examples, an indication of completion of the request for service may be received and, in response, the communication session may be terminated (e.g., computing platform 110 may transmit a command, instruction or signal causing termination of the communication session).

Accordingly, aspects described herein provide real-time determination of load at a plurality of entity locations and enable orchestration of services between entity locations based on determined load and using remote communication sessions. By dynamically determining not only a current load at each location, but also understanding, based on location specific thresholds, when additional assistance may be needed, the arrangements described provide efficient orchestration of associates to satisfy requests of users. Further, by implementing location specific rules identifying associates having particular skills (e.g., language skills, products or services in which associates are experts, or the like), the system may effectively identify appropriate remote locations and services to provide.

Although aspects described herein are directed to identifying remote associates to address requests for users at a first entity location, in some examples, an arrival of a user may be predicted (e.g., based on the user mobile device coordinates being within the geo-fenced area, based on a search performed via the mobile application executing on the user mobile device, or the like) and an associate may be reserved in advance of the user's arrival. In some examples, a machine-readable code, such as a quick response (QR) code may be transmitted to the user for display on the mobile device of the user to initiate the communication session with the reserved associate at the second entity location.

For instance, if a user searches in the mobile application for a nearest location based on zip code, this information may be transmitted to the identified location and arrival of that user may be predicted and additional resources, if needed, may be identified in advance of the user's arrival.

In some examples, a status of a flag of one or more entity locations may be displayed via, for instance, the mobile application associated with the enterprise organization to provide advance notice to users of a status of the entity location. For instance, a mobile application may include a display identifying one or more entity locations within a geographic area and may include an icon identifying whether the location is over threshold (e.g., a red icon) or under threshold (e.g., a green icon). Various other display arrangements may be used without departing from the invention.

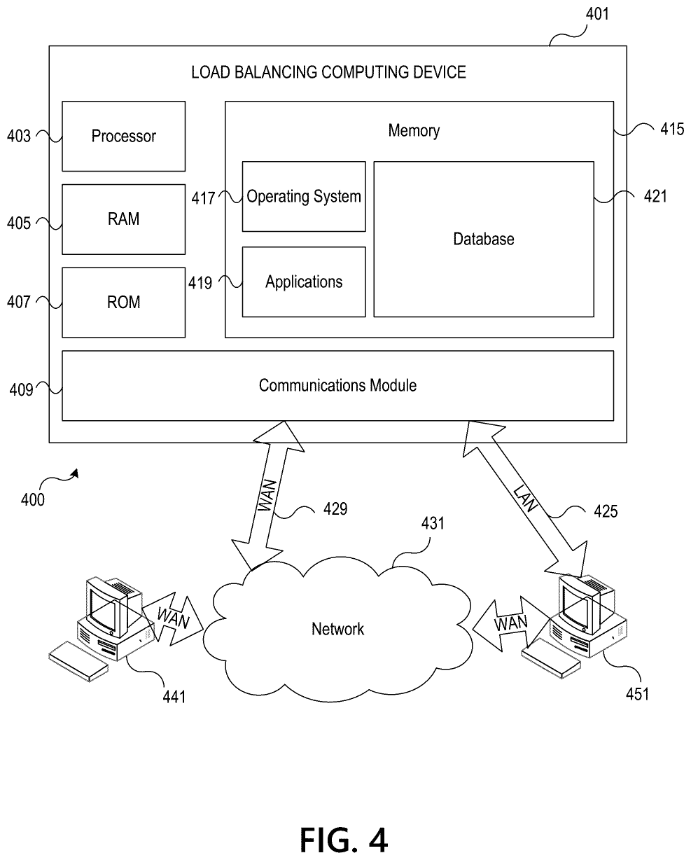

FIG. 4 depicts an illustrative operating environment in which various aspects of the present disclosure may be implemented in accordance with one or more example embodiments. Referring to FIG. 4, computing system environment 400 may be used according to one or more illustrative embodiments. Computing system environment 400 is only one example of a suitable computing environment and is not intended to suggest any limitation as to the scope of use or functionality contained in the disclosure. Computing system environment 400 should not be interpreted as having any dependency or requirement relating to any one or combination of components shown in illustrative computing system environment 400.

Computing system environment 400 may include load balancing computing device 401 having processor 403 for controlling overall operation of load balancing computing device 401 and its associated components, including Random Access Memory (RAM) 405, Read-Only Memory (ROM) 407, communications module 409, and memory 415. Load balancing computing device 401 may include a variety of computer readable media. Computer readable media may be any available media that may be accessed by load balancing computing device 401, may be non-transitory, and may include volatile and nonvolatile, removable and non-removable media implemented in any method or technology for storage of information such as computer-readable instructions, object code, data structures, program modules, or other data. Examples of computer readable media may include Random Access Memory (RAM), Read Only Memory (ROM), Electronically Erasable Programmable Read-Only Memory (EEPROM), flash memory or other memory technology, Compact Disk Read-Only Memory (CD-ROM), Digital Versatile Disk (DVD) or other optical disk storage, magnetic cassettes, magnetic tape, magnetic disk storage or other magnetic storage devices, or any other medium that can be used to store the desired information and that can be accessed by load balancing computing device 401.

Although not required, various aspects described herein may be embodied as a method, a data transfer system, or as a computer-readable medium storing computer-executable instructions. For example, a computer-readable medium storing instructions to cause a processor to perform steps of a method in accordance with aspects of the disclosed embodiments is contemplated. For example, aspects of method steps disclosed herein may be executed on a processor on load balancing computing device 401. Such a processor may execute computer-executable instructions stored on a computer-readable medium.

Software may be stored within memory 415 and/or storage to provide instructions to processor 403 for enabling load balancing computing device 401 to perform various functions as discussed herein. For example, memory 415 may store software used by load balancing computing device 401, such as operating system 417, application programs 419, and associated database 421. Also, some or all of the computer executable instructions for load balancing computing device 401 may be embodied in hardware or firmware. Although not shown, RAM 405 may include one or more applications representing the application data stored in RAM 405 while load balancing computing device 401 is on and corresponding software applications (e.g., software tasks) are running on load balancing computing device 401.

Communications module 409 may include a microphone, keypad, touch screen, and/or stylus through which a user of load balancing computing device 401 may provide input, and may also include one or more of a speaker for providing audio output and a video display device for providing textual, audiovisual and/or graphical output. Computing system environment 400 may also include optical scanners (not shown).

Load balancing computing device 401 may operate in a networked environment supporting connections to one or more other computing devices, such as computing device 441 and 451. Computing devices 441 and 451 may be personal computing devices or servers that include any or all of the elements described above relative to load balancing computing device 401.

The network connections depicted in FIG. 4 may include Local Area Network (LAN) 425 and Wide Area Network (WAN) 429, as well as other networks. When used in a LAN networking environment, load balancing computing device 401 may be connected to LAN 425 through a network interface or adapter in communications module 409. When used in a WAN networking environment, load balancing computing device 401 may include a modem in communications module 409 or other means for establishing communications over WAN 429, such as network 431 (e.g., public network, private network, Internet, intranet, and the like). The network connections shown are illustrative and other means of establishing a communications link between the computing devices may be used. Various well-known protocols such as Transmission Control Protocol/Internet Protocol (TCP/IP), Ethernet, File Transfer Protocol (FTP), Hypertext Transfer Protocol (HTTP) and the like may be used, and the system can be operated in a client-server configuration to permit a user to retrieve web pages from a web-based server.

The disclosure is operational with numerous other computing system environments or configurations. Examples of computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like that are configured to perform the functions described herein.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, Application-Specific Integrated Circuits (ASICs), Field Programmable Gate Arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, one or more steps described with respect to one figure may be used in combination with one or more steps described with respect to another figure, and/or one or more depicted steps may be optional in accordance with aspects of the disclosure

What is claimed is:

1. A computing platform, comprising:
at least one processor;
a communication interface communicatively coupled to the at least one processor; and
a memory storing computer-readable instructions that, when executed by the at least one processor, cause the computing platform to:
identify current load data for a plurality of entity locations, wherein the current load data is based on one or more of:
current global positioning system coordinates of a user mobile device being within a predetermined radius of geo-location coordinates of an entity location;
identification of one or more users within an entity location by an associate of the entity location; or
image data captured of a user entering or exiting an entity location;
evaluate, in real-time and by a load checking engine, whether load data for each entity location exceeds a threshold;
responsive to determining that one or more entity locations of the plurality of entity locations have load data that exceeds the threshold, flag the one or more entity locations as over threshold;
responsive to determining that one or more entity locations of the plurality of entity locations have load data that does not exceed the threshold, flag the one or more entity locations as under threshold;
receive, from a user at a first entity location, a user request for service, wherein the user request for service includes parameters of one of: the user or the request;
determine, by a central assignment system, whether the first entity location is flagged as under threshold or over threshold;
based on determining that the first entity location is flagged as under threshold, assign the user to an associate at the first entity location;
based on determining that the first entity location is flagged as over threshold:
identify a second entity location that is flagged as under threshold and matches the parameters of the one of: the user or the request;
initiate a communication session between a computing device at the first entity location and a computing device at the second entity location; and
execute the request for service by an associate located at the second entity location for the user at the first entity location via the communication session between the computing device at the first entity location and the computing device at the second entity location.

2. The computing platform of claim 1, further including instructions that, when executed, cause the computing platform to:
receive an indication of completion of the request for service; and
terminate the communication session between the computing device at the first entity location and the computing device at the second entity location.

3. The computing platform of claim 1, wherein the parameters of one of: the user or the request are retrieved from a user profile identified based on the user request for service.

4. The computing platform of claim 1, wherein the parameters of one of: the user or the request are retrieved from a user profile identified based on a mobile application executing on a mobile device of the user.

5. The computing platform of claim 1, wherein the communication session between the computing device at the first entity location and the computing device at the second entity location is a video communication session.

6. The computing platform of claim 1, wherein the predetermined radius includes a geo-fence.

7. The computing platform of claim 1, wherein identifying the current load data for the plurality of entity locations based on image data captured of a user entering or exiting an entity location includes analyzing the image data using facial recognition techniques.

8. The computing platform of claim 1, wherein identifying the current load data for a plurality of entity locations based on current global positioning system coordinates of a user mobile device being within a predetermined radius of geo-location coordinates of an entity location further includes determining that the current global positioning system coordinates of the user mobile device match the geo-location coordinates of the entity location.

9. A method, comprising:
identifying, by a computing platform, the computing platform having at least one processor and memory, current load data for a plurality of entity locations, wherein the current load data is based on one or more of:
current global positioning system coordinates of a user mobile device being within a predetermined radius of geo-location coordinates of an entity location;
identification of one or more users within an entity location by an associate of the entity location; or
image data captured of a user entering or exiting an entity location;
evaluating, in real-time and by a load checking engine of the computing platform, whether load data for each entity location exceeds a threshold;
responsive to determining that one or more entity locations of the plurality of entity locations have load data that exceeds the threshold, flagging, by the at least one processor, the one or more entity locations as over threshold;
responsive to determining that one or more entity locations of the plurality of entity locations have load data that does not exceed the threshold, flagging, by the at least one processor, the one or more entity locations as under threshold;
receiving, from a user at a first entity location and by the at least one processor, a user request for service, wherein the user request for service includes parameters of one of: the user or the request;
determining, by a central assignment system of the computing platform, whether the first entity location is flagged as under threshold or over threshold;
based on determining that the first entity location is flagged as under threshold, assigning, by the at least one processor, the user to an associate at the first entity location;
based on determining that the first entity location is flagged as over threshold:
identifying, by the at least one processor, a second entity location that is flagged as under threshold and matches the parameters of the one of: the user or the request;
initiating, by the at least one processor, a communication session between a computing device at the first entity location and a computing device at the second entity location; and
executing, by the at least one processor, the request for service by an associate located at the second entity location for the user at the first entity location via the communication session between the computing device at the first entity location and the computing device at the second entity location.

10. The method of claim 9, further including:
receiving, by the at least one processor, an indication of completion of the request for service; and
terminating, by the at least one processor, the communication session between the computing device at the first entity location and the computing device at the second entity location.

11. The method of claim 9, wherein the parameters of one of: the user or the request are retrieved from a user profile identified based on the user request for service.

12. The method of claim 9, wherein the parameters of one of: the user or the request are retrieved from a user profile identified based on a mobile application executing on a mobile device of the user.

13. The method of claim 9, wherein the communication session between the computing device at the first entity location and the computing device at the second entity location is a video communication session.

14. The method of claim 9, wherein the predetermined radius includes a geo-fence.

15. The method of claim 9, wherein identifying the current load data for the plurality of entity locations based on image data captured of a user entering or exiting an entity location includes analyzing the image data using facial recognition techniques.

16. The method of claim 9, wherein identifying the current load data for a plurality of entity locations based on current global positioning system coordinates of a user mobile device being within a predetermined radius of geo-location coordinates of an entity location further includes determining that the current global positioning system coordinates of the user mobile device match the geo-location coordinates of the entity location.

17. One or more non-transitory computer-readable media storing instructions that, when executed by a computing platform comprising at least one processor, memory, and a communication interface, cause the computing platform to:
identify current load data for a plurality of entity locations, wherein the current load data is based on one or more of:
current global positioning system coordinates of a user mobile device being within a predetermined radius of geo-location coordinates of an entity location;
identification of one or more users within an entity location by an associate of the entity location; or
image data captured of a user entering or exiting an entity location;
evaluate, in real-time and by a load checking engine, whether load data for each entity location exceeds a threshold;
responsive to determining that one or more entity locations of the plurality of entity locations have load data that exceeds the threshold, flag the one or more entity locations as over threshold;
responsive to determining that one or more entity locations of the plurality of entity locations have load data that does not exceed the threshold, flag the one or more entity locations as under threshold;
receive, from a user at a first entity location, a user request for service, wherein the user request for service includes parameters of one of: the user or the request;
determine, by a central assignment system, whether the first entity location is flagged as under threshold or over threshold;
based on determining that the first entity location is flagged as under threshold, assign the user to an associate at the first entity location;
based on determining that the first entity location is flagged as over threshold:
identify a second entity location that is flagged as under threshold and matches the parameters of the one of: the user or the request;
initiate a communication session between a computing device at the first entity location and a computing device at the second entity location; and
execute the request for service by an associate located at the second entity location for the user at the first entity location via the communication session between the computing device at the first entity location and the computing device at the second entity location.

18. The one or more non-transitory computer-readable media of claim 17, further including instructions that, when executed, cause the computing platform to:
receive an indication of completion of the request for service; and
terminate the communication session between the computing device at the first entity location and the computing device at the second entity location.

19. The one or more non-transitory computer-readable media of claim 17, wherein the communication session between the computing device at the first entity location and the computing device at the second entity location is a video communication session.

20. The one or more non-transitory computer-readable media of claim 17, wherein identifying the current load data for the plurality of entity locations based on image data captured of a user entering or exiting an entity location includes analyzing the image data using facial recognition techniques.
